(19) United States
(12) Patent Application Publication
(10) Pub. No.: US 2025/0123054 A1
(43) Pub. Date: Apr. 17, 2025

(54) Drying tower for bulk materials

(71) Applicant: STELA Laxhuber GmbH, Massing (DE)

(72) Inventors: Christoph Höfler, Aldersbach (DE); Michael Stummer, Taufkirchen/Vils (DE); Thomas Christian Laxhuber, Massing (DE)

(73) Assignee: STELA Laxhuber GmbH, Massing (DE)

(21) Appl. No.: 18/910,254

(22) Filed: Oct. 9, 2024

(30) Foreign Application Priority Data
Oct. 11, 2023 (EP) 23 202 884.5

(51) Int. Cl. F26B 17/12

(52) U.S. Cl. CPC F26B 17/122; F26B 2200/06

(57) ABSTRACT

A drying tower for bulk materials, in particular agricultural grains, includes a drying zone through which bulk material to be dried must pass from top to bottom, and an air guide for passing air through the drying zone. An air inlet is provided for introducing fresh air from the surroundings of the drying tower as supply air into the drying zone. An air outlet is provided for discharging exhaust air from the drying zone. A heat exchanger is provided for discharging heat from the exhaust air to the fresh air and an air return line for exhaust air is connected to the air outlet and the heat exchanger. An air supply line for fresh air is connected to the heat exchanger and the air inlet.

### CROSS-REFERENCE TO RELATED APPLICATION

This application claims the benefit of European Patent Application EP 23202884.5, filed on Oct. 11, 2023, the content of which is incorporated by reference in its entirety.

### BACKGROUND

In drying towers for bulk material, which are also referred to as column dryers, in particular for use with agricultural products, in particular grains such as cereals and corn, as well as rapeseed or sunflowers, the bulk material is dried with warm air. These drying methods have become established in the agricultural sector because a powerful, high-quality, and gentle drying of the agricultural grains is possible. The investment and operating costs are also low compared to other drying processes such as freeze drying, vacuum drying, or radiation drying. In general, the so-called continuous flow dryer has become established, in which the drying zones are arranged one after the other in a vertical drying column and the bulk material to be dried passes through them from top to bottom.

The air guide initially runs across the drying column. Heated supply air flows in on one side of the drying column and then flows through the bulk product that is arranged therein. The product/bulk material heats up and releases its moisture into the passing warm air. The bulk material dries. In return, the air cools down and becomes more humid. The moist air escapes as exhaust air on the other side of the drying column. The supply air and/or exhaust air is conveyed by motor-driven fans that are arranged in the air supply and/or air exhaust.

Such a generic drying tower is known from DE 20 2004 018 492 U1. A warm air generator and several drying levels arranged one above the other as well as air guide ducts for supplying air at different temperatures to different drying levels are provided. At least two drying levels are each assigned their own warm air generators, wherein the warm air generators can be operated independently of one another. The air is supplied through a common air supply shaft and extracted by a fan on the side of a guide shaft for the bulk material opposite the warm air generators. This type of air guide is technically comparatively complex and not very energy efficient.

### SUMMARY

A drying tower for bulk material is provided, in particular for agricultural grains, with at least one drying zone through which the bulk material to be dried passes from top to bottom. The drying tower is provided with an air guide for passing air through the at least one drying zone, in which at least one air inlet is provided for introducing fresh air from the surroundings of the drying tower as supply air into the at least one drying zone. Heat recovery from exhaust air of at least one drying zone is provided. For this purpose, at least one heat exchanger is provided for transferring heat from the exhaust air to the fresh air and at least one air return line for exhaust air is provided, which is connected to the at least one air outlet and the at least one heat exchanger. At least one air supply line for fresh air is connected to the heat exchanger and the air inlet. Thus, the exhaust air is supplied and passed through the heat exchanger via the air return line and the fresh air is supplied to the air inlet via the air supply line after the fresh air has passed through the heat exchanger. Thereby, the energy consumption of the drying tower is significantly reduced compared to known drying towers.

Preheating of the fresh air supplied to the air inlet by about 20 Kelvin is achieved by means of such heat recovery. Energy required for the preheating originates from the exhaust air and preheating can thus be achieved without additional energy input.

Advantageously, the at least one heat exchanger of the heat recovery is dimensioned such that moisture from the exhaust air condenses thereon. Moisture condenses when the relative humidity of the relevant air reaches 100% (in words: one hundred percent). The relative humidity in air increases when the air, as in this case the warm exhaust air, cools down. The desired condensation is preferably achieved by condensing the moisture on a separating surface of the at least one heat exchanger. For this purpose, the exhaust air releases so much thermal energy at the separating surface that the relative humidity in the exhaust air reaches 100%. The at least one heat exchanger thus advantageously has four functions. The first function is to dehumidify the exhaust air that flows through the at least one heat exchanger. The second function is to heat the fresh air supplied and passed through the at least one heat exchanger. The third function is to reduce the relative humidity of the supplied fresh air by heating the fresh air. The fourth function is the dedusting of the exhaust air in the heat exchanger through condensation and the associated adhesion of dust to the moist surfaces of the heat exchanger.

Particularly preferably, the supplied fresh air is also further heated as such. For this purpose, the drying tower is preferably provided with an air heater for heating the fresh air supplied through the air inlet.

In this case, the fresh air from the surroundings of the drying tower, which is preheated in at least one heat exchanger, is particularly preferably further adjusted to a temperature between 100° C. and 145° C., in particular between 110° C. and 125° C. These temperature ranges are particularly advantageous with regard to the overall energy balance of such a drying tower.

For moving air through the drying tower, a first air suction device/fan is preferably provided for sucking exhaust air from the at least one drying zone. With the air suction device, a suction is generated through the at least one drying zone. Furthermore, a second air suction device is preferably provided for sucking fresh air from the at least one heat exchanger to the air inlet. Thus, the exhaust air return and/or the fresh air supply are preferably each provided with a suction device by means of which the air to be conveyed is first sucked through the material to be dried and then returned or discharged. By conveying the air by suction rather than by blowing, a negative pressure can be created within the goods and the sections mentioned, which prevents dust from escaping from these areas.

Preferably, the at least one drying zone comprises a plurality of drying zones, wherein a first part of the drying zones, preferably the lower section of a drying column, is provided in front of/above a cooling region in the flow direction of the bulk material. A second part of the drying zones is then the upper region of the drying column arranged above this first part.

Furthermore, for an even higher energy yield in the drying tower, an air return/air recirculation system can preferably be provided for returning at least part of the exhaust air from the first part of the drying zones as supply air back to the first part of the drying zones.

Particularly preferably, the drying tower has a washing device operatively connected to the at least one heat exchanger for washing out condensate and dust from the exhaust air passed through the at least one heat exchanger. The washing device is particularly preferably located above the at least one heat exchanger, so that washing water is particularly preferably guided from above onto the at least one heat exchanger, which in turn is particularly preferably flowed through by the exhaust air from below. This creates a countercurrent of washing water and exhaust air, which leads to particularly effective washing out of condensate and dust from the exhaust air.

Furthermore, a separating device can preferably be operatively connected to the at least one heat exchanger for separating condensate and dust from the exhaust air passed through the heat exchanger. The separating device is particularly preferably designed as a belt filter. The separating device can be arranged below the at least one heat exchanger and thus also collect the washing water from the washing device and filter out condensate and dust. Instead of the belt filter, the use of a radial separator as a separating device is also conceivable.

The condensate and the dust from the exhaust air can then be removed from the separating device, collected, and fed to any further utilization.

A method is further provided for operating a drying tower for bulk material, in particular for agricultural grains, in which at least one drying zone is passed through by bulk material to be dried from top to bottom and air is passed through the drying zone. In this case, fresh air from the surroundings of the drying tower is introduced as supply air into the at least one drying zone at an air inlet. Heat is transferred from the exhaust air to the fresh air using at least one heat exchanger. Thus, the exhaust air is supplied to the heat exchanger via the air return line and passed through the heat exchanger and the fresh air is supplied to the air inlet via the air supply line after the fresh air has passed through the heat exchanger.

In such a method for operating a drying tower in accordance with the above-mentioned design, the fresh air supplied through the air inlet is preferably heated at an air heater.

With the air heater, fresh air from the surroundings of the drying tower is particularly preferably adjusted to a temperature between 100° C. and 145° C., in particular between 110° C. and 125° C.

### BRIEF DESCRIPTION OF THE DRAWINGS

FIG. 1 is a schematic, sectional side view of a drying tower for agricultural grains with a heat recovery device.

FIG. 2 is a schematic, partially sectioned side view of the drying tower according to FIG. 1.

FIG. 3 is a flowchart of a first exemplary embodiment of a method for operating a drying tower.

FIG. 4 is a flow diagram of a second embodiment of a method for operating a drying tower.

FIG. 5 is a flow diagram of a third embodiment of a method for operating a drying tower.

FIG. 6 is a flow diagram of a fourth embodiment of a method for operating a drying tower.

FIG. 7 is a flow diagram of a fifth embodiment of a method for operating a drying tower.

### DETAILED DESCRIPTION

A drying tower 10 for agricultural grains comprises a drying column 12 with at least one drying zone T16 to T1, an air supply 14, and an air exhaust 16.

On the top of the drying column 12 there is a filling opening 18 for bulk material 20 to be dried, in this case corn kernels. Due to the force of gravity acting on it, the bulk material 20 passes successively from above through at least one drying zone T16 to T1 of the drying column 12 downwards. The bulk material 20 flows down over roof-shaped air shafts (not shown in detail) which are open at the bottom.

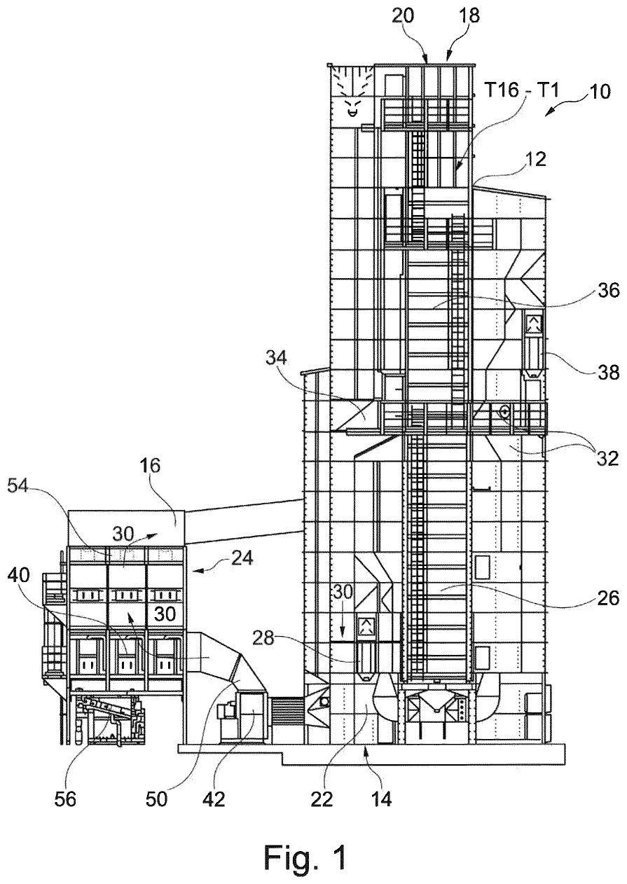

The air supply 14 is designed with an air inlet 22, which is formed as an air supply shaft at the lower end region of the drying tower 10, which is on the left in relation to FIG. 1. Fresh air 24 from the surroundings of the drying tower 10 passes through the air inlet 22 into a first part 26 of the drying zones T16 to T1, namely into the drying zones T8 to T3. This fresh air 24 is heated at the air inlet 22 in an air heater 28. The heated fresh air 24 is sucked as supply air through the first part 26 of the drying zones T16 to T1. There, the fresh air is enriched with moisture from the bulk material 20 and is discharged again from the drying column 12 on the right-hand side of these drying zones T8 to T3 as humidified exhaust air 30, which can also be referred to as intermediate air.

This exhaust air 30/intermediate air is guided vertically upwards to the right-hand side of the drying zones T16 to T9 by an air mover 32 in the form of a fan (in particular an axial fan or a radial fan) or air suction device. The drying zones T16 to T9 form a second part 36 of the drying zones T16 to T1. The exhaust air 30/intermediate air is there heated to a higher temperature level by means of a hot air flow from an additional air heater 38.

The exhaust air 30/intermediate air then passes through the second part 36 of the drying zones T16 to T1 and flows out as exhaust air 30 through an air outlet 34.

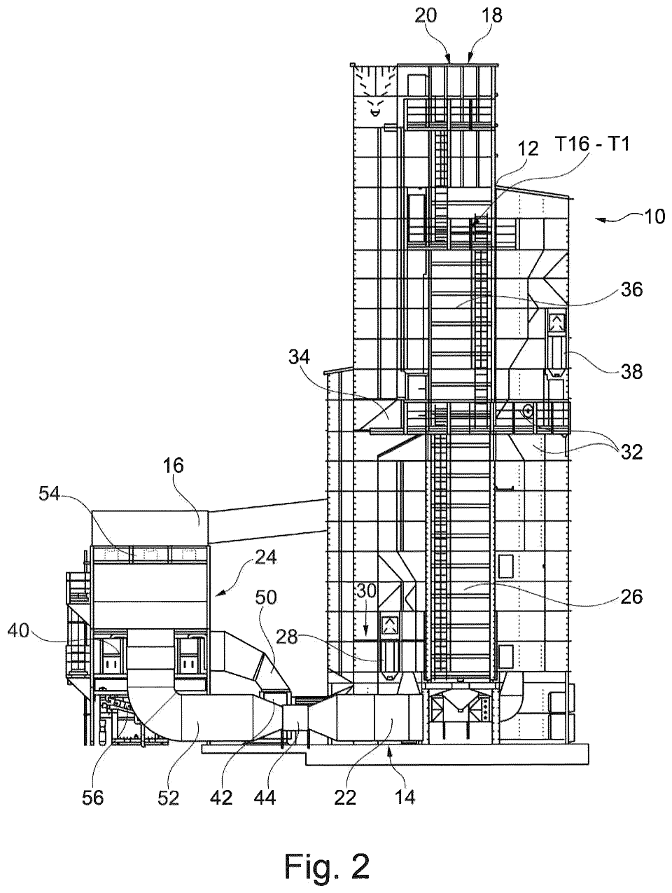

At least one heat exchanger 40 is provided downstream of the air outlet 34 for transferring heat from the exhaust air 30 to the fresh air 24. An air return line 50 for the exhaust air 30 is connected to the at least one air outlet 34 and the at least one heat exchanger 40 (see FIG. 1). At least one air supply line 52 for the fresh air 24 is also connected to the at least one heat exchanger 40, on the one hand, and the air inlet 22, on the other hand (see FIG. 2). Furthermore, a first air suction device 42 for sucking the exhaust air 30 from the at least one drying zone T16 to T1 (see FIG. 1) and a second air suction device 44 for sucking fresh air 24 from the at least one heat exchanger 40 to the air inlet 22 (see FIG. 2) are provided.

As can be clearly seen in FIG. 1, a washing device 54 is provided above the at least one heat exchanger 40, with several, in particular rotatable nozzles for spraying washing water and for removing and washing out condensate/dust from the exhaust air 30 guided through the heat exchanger.

In addition, a separating device 56 designed as a belt filter is assigned below the at least one heat exchanger 40 for separating dust from the condensate discharged from the heat exchanger. Alternatively, another type of separating device, such as a centrifuge, may also be provided.

The exhaust air is ultimately discharged further upwards from the drying tower 10 via an air exhaust 16.

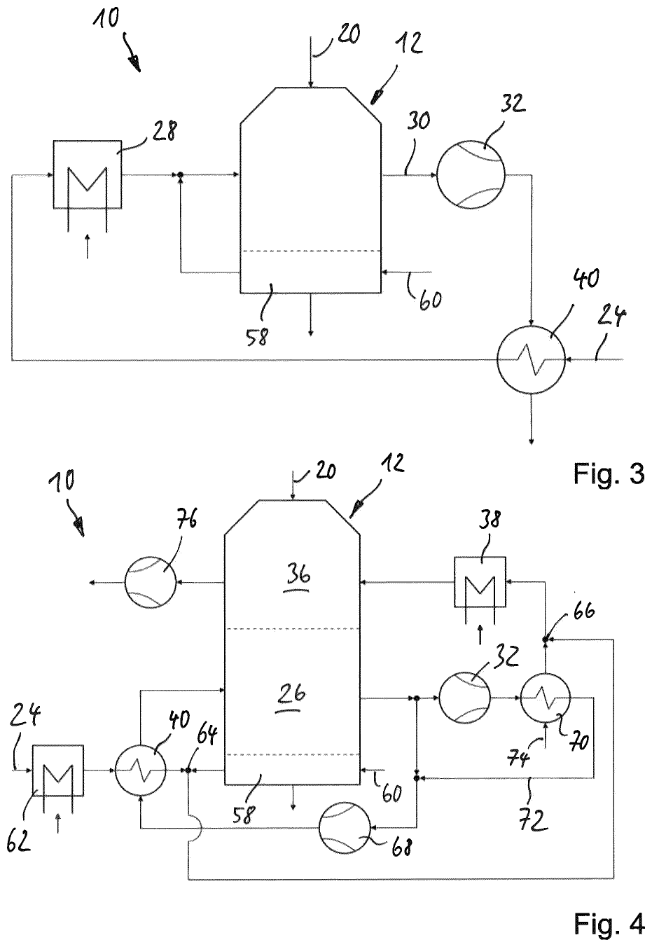

In FIG. 3, the operating principle of the solution for drying bulk materials in a drying tower is illustrated. The drying tower 10 comprises a drying column 12 with at least one drying zone through which bulk material 20 can pass from top to bottom and that furthermore has a cooling zone 58, in particular at its lower end. Fresh air 24 is supplied to the drying column 12 through the heat exchanger 40. The fresh air 24 preheated in this way is guided to the air heater 28, by which it is further heated. At the same time, fresh air is guided through the cooling zone 58 in order to cool the completely dried bulk material 20 there. This cooling air 60 is combined with the air heated by the air heater 28 and then fed into the drying column 12. By means of the air mover 32, the resulting exhaust air 30 is discharged again through the heat exchanger 40 while preheating the fresh air 24.

FIG. 4 shows an embodiment of the solution for drying bulk materials, in which the drying column 12 is divided into a first part 26 of drying zones and a second part 36 of drying zones. The fresh air 24 is first passed through a preheater 62 and then through the heat exchanger 40. The fresh air 24 then reaches a first collection point 64, to which the fresh air 60 from the cooling zone 58 is also supplied. The fresh air 24 and fresh air 60 are then led from the first collection point 64 to a second collection point 66.

In the first part 26 of the drying zones, the exhaust air 30 is circulated by means of an air suction device 68 and passed through the heat exchanger 40. A portion of the exhaust air 30 is discharged in the flow direction behind the drying zones with the air mover 32 and passed through a heat exchanger 70. This partial air 72 is fed back into the circulating air flow at the first part 26 of the drying zones. Further fresh air 74 is also passed through the heat exchanger 70, which is then preheated and passed past the second collection point 66 to the additional air heater 38, from where it is discharged into the second part 36 of the drying zones and through it to the outside by means of an air suction device 76.

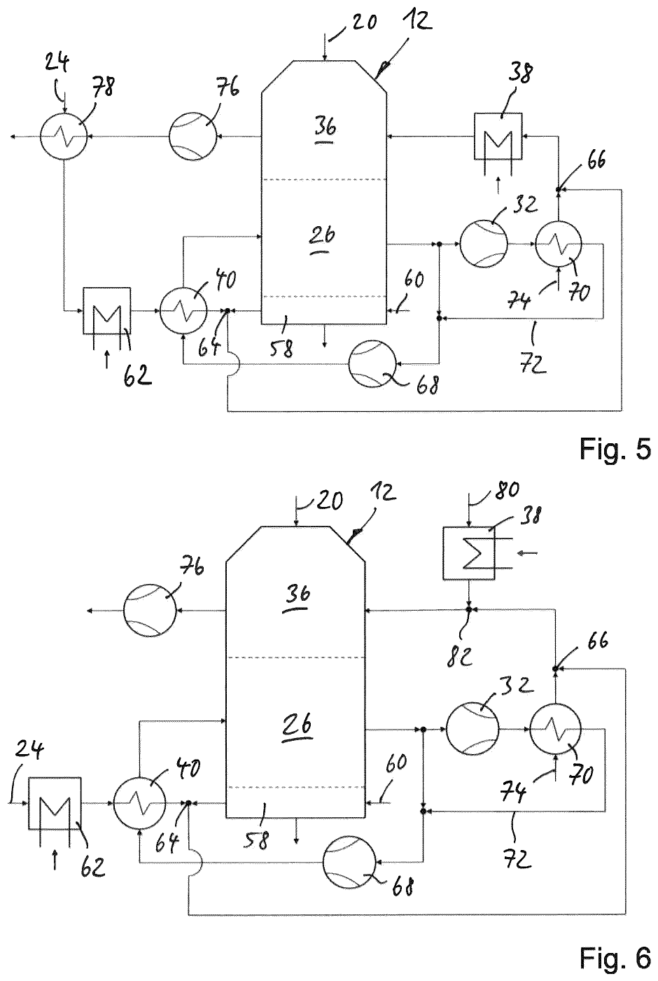

The embodiment according to FIG. 5 is constructed similarly to that shown in FIG. 4. There is only an additional heat exchanger 78 in the exhaust air flow behind the air suction device 76, through which the fresh air 24 is led to the preheater 62.

FIG. 6 shows an embodiment also based on FIG. 4, in which the only difference is that the additional air heater 38 is not connected directly into the supply air flow to the second part 36 of the drying zones, but instead preheats additional fresh air 80, which is then introduced into the supply air flow at a third collection point 82.

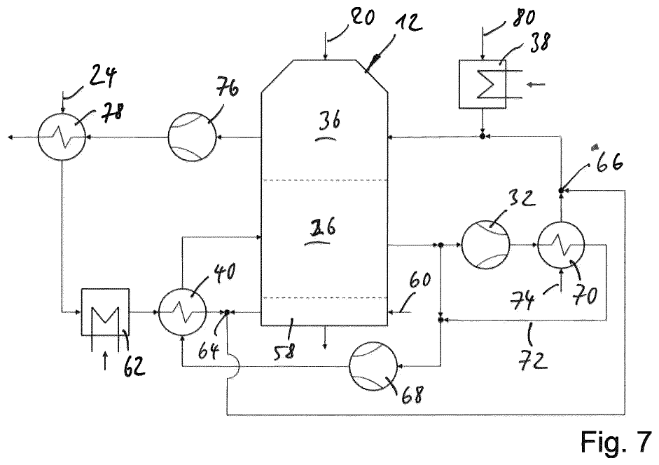

Finally, FIG. 7 shows an embodiment which is based on FIG. 4 and in which the arrangement of the heat exchanger 78 according to FIG. 5 is otherwise combined with the arrangement of the additional air heater 38 according to FIG. 6.

### LIST OF REFERENCE SYMBOLS

10 drying tower
12 drying column
14 air supply
16 air exhaust
18 filling opening
20 bulk material
22 air inlet
24 fresh air
26 first part of the drying zones (T8 to T3)
28 air heater
30 exhaust air
32 air mover
34 air outlet
36 second part of the drying zones (T16 to T9)
38 additional air heater
40 heat exchanger
42 first air suction device
44 second air suction device
50 air return line
52 air supply line
54 washing device
56 separating device
58 cooling zone
60 cooling air
62 preheater
64 first collection point
66 second collection point
68 air suction device
70 heat exchanger
72 partial air
74 further fresh air
76 air suction device
78 additional heat exchanger
80 further fresh air
82 third collection point

What is claimed is:

1. A drying tower (10) for bulk materials, comprising:
at least one drying zone (T16 to T1) through which a bulk material (20) to be dried passes from top to bottom;
at least one air guide for passing air through the at least one drying zone (T16 to T1), including
at least one air inlet (22) for introducing fresh air (24) from surroundings of the drying tower (10) as supply air into the at least one drying zone (T16 to T1) and
at least one air outlet (34) for discharging exhaust air (30) from the at least one drying zone (T16 to T1);
at least one heat exchanger (40) for transferring heat from the exhaust air (30) to the fresh air (24);
at least one air return line (50) for the exhaust air (30) connected to the at least one air outlet (34) and the at least one heat exchanger (40); and
at least one air supply line (52) for the fresh air (24) connected to the at least one heat exchanger (40) and the air inlet (22).

2. The drying tower (10) according to claim 1, further comprising
at least one air heater (28) for heating the fresh air (24).

3. The drying tower (10) according to claim 2,
wherein the air heater (28) adjusts the fresh air (24) to a temperature between 100° C. and 145° C.

4. The drying tower (10) according to claim 1, further comprising
a first air suction device (42) for sucking the exhaust air (30) from the at least one drying zone (T16 to T1) and
a second air suction device (44) for sucking the fresh air (24) from the at least one heat exchanger (40) to the air inlet (22).

5. The drying tower (10) according to claim 1,
wherein the at least one heat exchanger (40) is connected to a washing device (54) for washing out condensate and dust from the exhaust air (30) passed through the heat exchanger.

6. The drying tower (10) according to claim 1, further comprising
a separating device (56) for separating condensate and dust from the exhaust air (30) arranged below the at least one heat exchanger (40).

7. The drying tower (10) according to claim 6,
wherein the separating device (56) is a belt filter.

8. The drying tower (10) as in claim 1,
wherein the bulk material (20) is agricultural grains.

9. A method for operating a drying tower (10), comprising:
passing bulk material (20) to be dried from top to bottom through at least one drying zone (T16 to T1);
passing air through the at least one drying zone (T16 to T1), including
introducing fresh air (24) from surroundings of the drying tower (10) as supply air into the at least one drying zone (T16 to T1) at an air inlet (22) and
passing exhaust air (30) from the at least one drying zone (T16 to T1) to at least one heat exchanger (40); and
transferring heat in the at least one heat exchanger (40) from the exhaust air (30) to the fresh air (24).

10. The method according to claim 9, further comprising
heating the fresh air (24) supplied through the air inlet (22) at an air heater (28).

11. The method according to claim 10, further comprising
using the air heater (28) to adjust the fresh air (24) from the surroundings of the drying tower (10) to a temperature between 100° C. and 145° C.

12. The method according to claim 10, further comprising
using the air heater (28) to adjust the fresh air (24) from the surroundings of the drying tower (10) to a temperature between 110° C. and 125° C.
